(19) United States
(12) Patent Application Publication
(10) Pub. No.: US 2026/0208530 A1
(43) Pub. Date: Jul. 23, 2026

(54) IMPROVED ALUMINA REINFORCED RUBBER COMPOSITION

(71) Applicant: COMPAGNIE GENERALE DES ETABLISSEMENTS MICHELIN, Clermont-Ferrand (FR)

(72) Inventors: Jeremy John MEHLEM, Greenville, SC (US); Christopher PAPPAS, Charlotte, NC (US)

(21) Appl. No.: 19/143,148

(22) PCT Filed: Dec. 21, 2023
(86) PCT No.: PCT/US2023/085270

§ 371 Date: Jun. 25, 2025

Related U.S. Application Data
(60) Provisional application No. 63/435,751, filed on Dec. 28, 2022.

(51) Int. Cl. B60C 1/00; C08K 3/06; C08K 3/22; C08K 5/44; C08K 5/548; C08L 9/06

(52) U.S. Cl. CPC B60C 1/00; C08K 3/06; C08K 3/22; C08K 5/44; C08K 5/548; C08L 9/06; C08K 2003/2227; C08K 2003/2296

(57) ABSTRACT

Identified herein is a novel elastomeric composition having an alumina filler and a silane coupling agent, wherein the silane coupling agent is not a blocked mercapto silane and has a sulfur bridge having on average 2.5 sulfurs or less bridging sulfurs. The elastomeric composition shows surprisingly good tensile properties. The elastomeric composition may be particularly useful for rubber articles such as tires and tire treads.

### FIELD OF THE INVENTION

The subject matter of the present invention relates to a rubber composition utilizing an alumina oxide filler, and more particularly, a rubber composition using an alumina oxide as a filler and silane as a covering agent, which can be employed for the manufacture of tires, exhibiting superior properties to that of rubber compositions reinforced with alumina oxide and/or silica.

### BACKGROUND OF THE INVENTION

The lack of infrastructure to support charging of electric vehicles, the relatively long recharge rates and the desire to reduce the carbon footprint of electric vehicles still charged by fossil fuel derived electricity has kept vehicle efficiency, and in particular tire rolling resistance a top priority to tire designers. Meanwhile the increase in weight and high torque and power of electric vehicles calls for continued improvements to adherence in both dry and wet conditions and improvements to wear.

Many solutions have been proposed for lowering the rolling resistance and improving adherence of tires, but these solutions are associated with a loss of abrasion resistance. Conventional white fillers such as silica, alumina, bentonite, clay, kaolin, chalk, titanium oxide, talc and the like result in improved rolling resistance and traction in dry and wet conditions, but also in a loss in resistance to wear.

Alumina oxide has been researched by the rubber and tire industry as means to improve tire performance. Improvements to rolling resistance been shown to be achievable by using an Alumina filler in combination with a silane linking agent as described, e.g., in U.S. Pat. No. 5,900,449 describing the use of an alumina oxide reinforced rubber composition with a conventional silane Si69 or in European Pat. No. EP 3,345,775 describing an alumina oxide reinforced rubber composition with a novel NXT silane.

Silanes coupling agents are well known to the person skilled in the art and have been described, for example in U.S. Pat. No. 7,202,295. “Coupling agent” is more precisely understood to mean an agent capable of establishing a sufficient chemical and/or physical connection between the filler in question and the elastomer; such a coupling agent, which is at least bifunctional, has, for example, the simplified general formula “Y-T-X”, in which:
Y represents a functional group (“Y” function) which is capable of bonding physically and/or chemically with the inorganic filler, such a bond being able to be established, for example, between a silicon atom of the coupling agent and the surface hydroxyl (OH) groups of the inorganic filler (for example, surface silanols in the case of silica);
X represents a functional group (“X” function) which is capable of bonding physically and/or chemically with the elastomer, for example by means of a sulfur atom;
T represents a group making it possible to link Y and X.

The coupling agents must particularly not be confused with simple agents for covering the filler in question which, in known manner, may comprise the Y function which is active with respect to the filler but are devoid of the X function which is active with respect to the elastomer.

Improvements to alumina reinforced rubber compositions for the tire industry, which have shown promising results compared to conventional silica mixes, would be desirable. Despite the advantages of alumina as a filler, the tire industry has yet to adopt it in favor of conventional silica mixes as industrial mixes utilizing alumina often do not have the performance characteristics expected. The discovery of a rubber composition having industrially scalable formulation having superior results would be of particular use in the tire industry.

### SUMMARY OF THE INVENTION

Aspects and advantages of the invention will be set forth in part in the following description, or may be obvious from the description, or may be learned through practice of the invention.

In one exemplary embodiment, a rubber composition is described comprising a dienic rubber elastomer and a reinforcing alumina filler with a silane coupling agent having 2.5 or less on average bridging sulfurs which is not a blocked mercapto silane and a vulcanizing system.

In another exemplary embodiment, the rubber composition contains less than 2.4 or less on average bridging sulfurs.

In another exemplary embodiment, a rubber composition is described comprising a dienic rubber elastomer and a reinforcing alumina filler with a silane coupling agent having 2.5 or less on average bridging sulfurs which is not a blocked mercapto silane and a vulcanizing system and no DPG.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a plot of the stress-strain curve of the elastomers of example 1.

FIG. 2 provides a plot of the stress-strain curve of the elastomers of example 2.

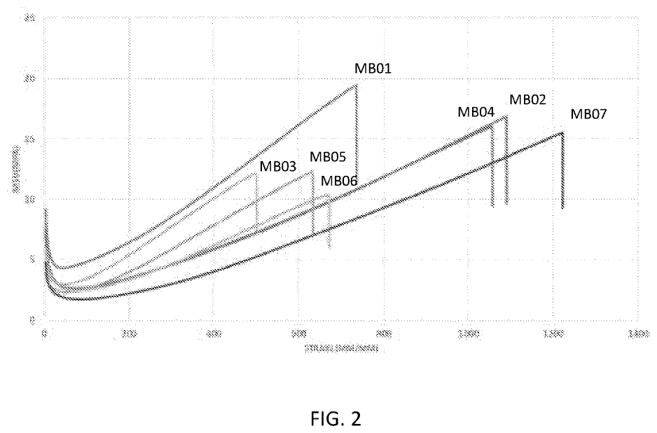

FIG. 3 provides a plot of the stress-strain curve of the elastomers of example 3.

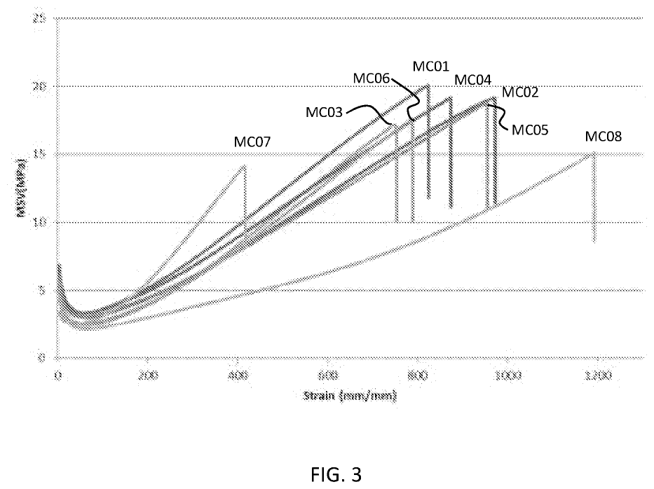

The use of identical or similar reference numerals in different figures denotes identical or similar features.

### DETAILED DESCRIPTION OF THE INVENTION

The present invention provides a rubber composition utilizing an alumina reinforcing filler and a non-blocked mercapto group silane having a sulfur rank of 2.4 or less. For purposes of describing the invention, reference now will be made in detail to embodiments and/or methods of the invention. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

The rubber composition in accordance with the invention is particularly useful for to the manufacture of tire treads intended to be fitted on passenger cars, light trucks, vans, bicycles, motorcycles and trucks, aircraft, and civil engineering, agricultural and handling machinery. Treads comprising the rubber composition as disclosed in accordance with the invention can be used in the manufacturing of new tires or for retreading worn tires.

The alumina which can be employed as a reinforcing filler may have a NSA surface area ranging from 30 to 400 m²/g and preferably from 80 to 250 m²/g, and a NSA surface area by volume of 100 to 1360 m²/cm³. VP Aeroperl ALU 100/30 alumina from Evonik and Baikalox CR125 from Baikowski are two examples that can be employed in accordance with the invention. The volumes of the fillers were similar, however, the aluminas are smaller by weight than the silica reference used in the examples below. VP Aeroperl had an NSA surface area of 100 m²/g and a NSA surface area by volume of 290 m²/cm³. The Baikalox CR125 had an NSA surface area of 101 m²/g and a NSA surface area by volume of 340 m²/cm³. The reference silica RP160 (Solvay Zeosill165MP) had an NSA surface area of 159 m²/g and a NSA surface area by volume of 319 m²/cm³. The pH of the alumina is typically higher than 7-10. Where as the refence silica is 6.5 pH or lower. The aluminas employed in this work are also know to be microporous. Micro-porosity is assessed by looking at the difference between surface area measured by BET and CTAB as shown in Table 1 below. The greater the difference, the greater the assessed microporosity.

TABLE 1
Properties of alumina utilized.

| Filler | NSA (m²/g) | CTAB (m²/g) |
|---|---|---|
| Solvay 1165MP | 159 | 158 |
| CR125 | 101 | 83.6 |
| Aeroperl | 100 | 71.7 |

Silane coupling agents are well known and are sulfur-containing organosilicon compounds that react with the silanol groups of the silica during mixing and with the elastomers during vulcanization to provide improved properties of the cured rubber composition. Any of the organosilicon compounds that contain less than an average 2.4 sulfurs in the bridge have been found to be surprisingly useful for practicing embodiments of the present invention. Just as surprising, it has been found that blocked-mercapto group silanes have not shown as positive of results as other non blocked-mercapto group silanes that otherwise contain less than an average of 2.4 sulfurs. Examples of suitable non blocked-mercapto group silane coupling agents having less than an average of 2.4 sulfurs in the bridge include 3,3′-bis(triethoxysilylpropyl) disulfide (known Si75 and Si266).

Silane having more than an average of 2.4 sulfurs in the bridge was S169 or bis [3-(triethoxysilyl) propyl]tetrasulfide shown as structure (I) below:

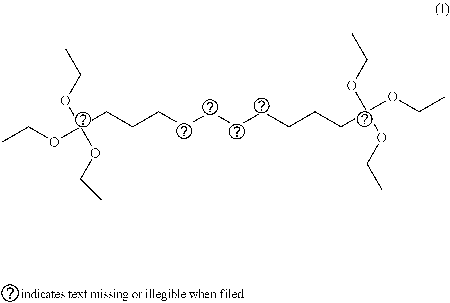 [SMILES: CCOC(CCCCCCCCCCC(OCC)(OCC)OCC)(OCC)OCC]

Silanes having less than an average of 2.4 sulfurs in the bridge include SI-75 or SI266, bis(triethoxysilylpropyl) disulfide; MESPT silane; NXT Reg.; NXT v45; DSP18; Octeo; Si363; and MPS, mercapto propyl tri-ethoxy silane, shown respectively as the structures (II), (III), (IV), (V), (VI), (VII), (VIII) and (IX) below. Octeo (VII) is noted to not contain a reactive sulfur group and is therefore considered the least reactive of these silanes:

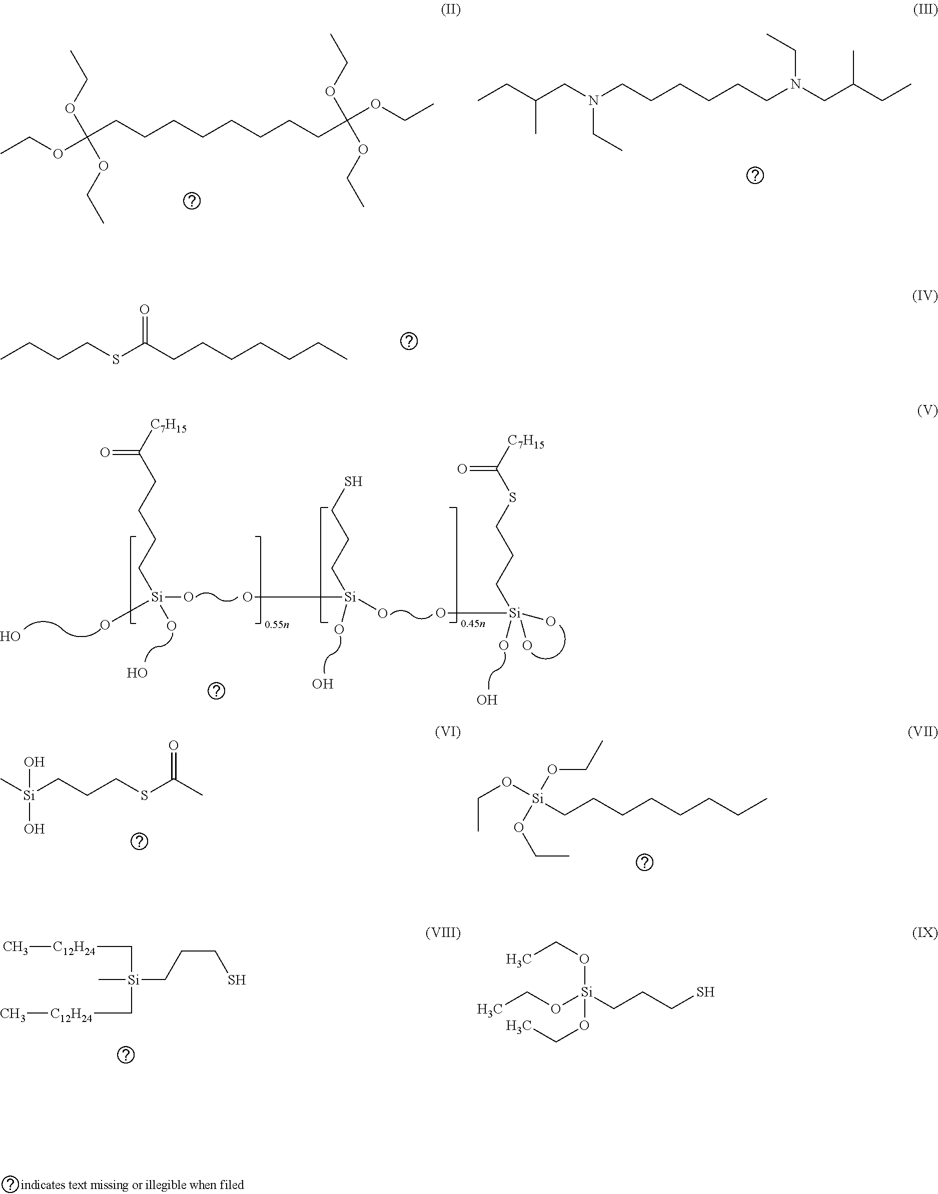

Typically, the amount added is between 4 wt. % and 10 wt. % or alternatively between 5 wt. % and 9 wt. % of the total weight of the alumina added to the rubber composition.

Elastomers: The rubber elastomers disclosed in the embodiments herein are styrene-butadiene rubber (SBR). The rubber elastomers suitable for use with particular embodiments of the present invention include essentially unsaturated diene elastomers and also include highly unsaturated diene elastomers, for example, polybutadiene rubber (BR), polyisoprene rubber (IR), natural rubber (NR), isobutylene isoprene rubber (IR) butadiene copolymers, isoprene copolymers and mixtures of these elastomers. The polyisoprenes include synthetic cis-1,4 polyisoprene, which may be characterized as possessing cis-1,4 bonds at more than 90 mol. % or alternatively, at more than 98 mol. %. Particular embodiments of the disclosed rubber compositions include only natural rubber.

Also suitable for use in particular embodiments of the present invention are rubber elastomers that are copolymers and include, for example, butadiene-styrene copolymers (SBR), butadiene-isoprene copolymers (BIR), isoprene-styrene copolymers (SIR) and isoprene-butadiene-styrene copolymers (SBIR) and mixtures thereof.

The elastomer system can be a blend of various elastomers with a total of 100 phr.

Reinforcing Fillers: In addition to the alumina reinforcing filler mentioned above, other reinforcing fillers including carbon black and silica may be included.

Other fillers may also be included as reinforcing fillers to the elastomer system, for example, graphene, graphite, zeolite, and so forth.

Plasticizers: The plasticizers include oils, resins (from petroleum or other natural renewable resources, e.g., sunflower seeds, citrus orange peels). Processing oils are well known to one having ordinary skill in the art, are generally extracted from petroleum and are classified as being paraffinic, aromatic or naphthenic type processing oil, including MES and TDAE oils. Processing oils are also known to include, inter alia, plant-based oils, such as sunflower oil, rapeseed oil and vegetable oil. Some of the rubber compositions disclosed herein may include an elastomer, such as a styrene-butadiene rubber, that has been extended with one or more such processing oils but such oil is limited in the rubber composition of particular embodiments as being no more than 40 phr of the total elastomer content of the rubber composition.

Vulcanizing System: The vulcanization system is preferably, for particular embodiments, one based on sulfur but other vulcanization agents known to one skilled in the art may be useful as well, for example, peroxide and ionic crosslinking agents. Vulcanization agents as used herein are those materials that cause the cross-linkage of the rubber and therefore may be added only to the productive mix so that premature curing does not occur, such agents including, for example, elemental sulfur, sulfur donating agents, and peroxides.

The rubber composition may also include vulcanization retarders, a vulcanization system based, for example, on sulfur or on a peroxide, vulcanization accelerators, vulcanization activators, and so forth. The vulcanization system may further include various known secondary accelerators or vulcanization activators, such as zinc oxide, stearic acid and guanidine derivatives (in particular diphenylguanidine, or “DPG”).

Antidegredants: The rubber compositions disclosed herein may further include, in addition to the compounds already described, all or part of the components often used in diene rubber compositions intended for the manufacture of tires, such as additional protective agents of the type that include antioxidants and/or antiozonants, such as 6PPD, 77PD, TMQ, hindered phenol, and wax.

Other Components: There may also be added, if desired, one or more conventional non-reinforcing fillers such as clays, bentonite, talc, chalk kaolin, aluminosilicate, fiber, or coal.

Diphenylguanine or “DPG” is typically used as an accelerator for the curing of rubber compositions. Rubber compositions lacking “DPG” generally have a longer cure time.

### Mixing and Production:

The rubber compositions that are embodiments of the present invention may be produced in suitable mixers in a manner known to those having ordinary skill in the art. Typically, the mixing may occur using two successive preparation phases, a first phase of thermo-mechanical working at high temperature followed by a second phase of mechanical working at a lower temperature.

The first phase, sometimes referred to as a “non-productive” phase, includes thoroughly mixing, typically by kneading, the various ingredients of the composition but excluding some of the vulcanization system such as the vulcanization agents, the accelerators, and the retarders. This first phase is carried out in a suitable kneading device, such as an internal mixer of the Banbury type, until under the action of the mechanical working and the high shearing imposed on the mixture, a maximum temperature of generally between 120° C. and 190° C. is reached, indicating that the components are well dispersed.

After cooling the mixture a second phase of mechanical working is implemented at a lower temperature. Sometimes referred to a “productive” phase, this finishing phase consists of incorporating some of the aforementioned vulcanization system that were not added in the “non-productive” phase, including the vulcanization agents, the accelerators, and the retarders into the rubber composition using a suitable device, such as an open mill. It is performed for an appropriate time (typically, for example, between 1 and 30 minutes or between 7 and 15 minutes), and at a sufficiently low temperature, i.e., lower than the vulcanization temperature of the mixture, to protect against premature vulcanization.

The rubber composition can be formed into useful articles, including tire components. Tire treads, for example, may be formed as tread bands and then later made a part of a tire or they be formed directly onto a tire carcass by, for example, extrusion and then cured in a mold. Other components such as those located in the bead area of the tire or in the sidewall may be formed and assembled into a green tire and then cured with the curing of the tire.

The invention is further illustrated by the following examples, which are to be regarded only as illustrations and not delimitative of the invention in any way.

The characterization of the innovative alumina and silane used, and the properties of the rubber compositions disclosed in the examples were evaluated as described below.

Rheometer: the curing and cured characteristics of the rubber compositions are conducted by using MDR (moving die rheometer) according to ASTM D2084. The test is conducted at 150° C.

Surface Area Measurement: The BET surface measurement is performed according to the Brunauer-Emmett-Teller method described in the “Journal of the American Society” Vol. 60, page 309, February 1938 and corresponding to NFT standard 45007 (November 1987) The CTAB surface measurement is performed in accordance with ASTM D6845-20 Standard Test Method for Silica, Precipitated, Hydrated-CTAB (Cetyltrimethylammonium Bromide) Surface Area.

### Example 1

In this example Aeroperl alumina-reinforced compositions using different silanes are compared. An SBR elastomer having a TG=−65° C. was used.

In these compositions all the parts are expressed as weights per hundred parts of elastomer. In this example, the components listed in Table 1 below combined with an antidegradant package comprising an antioxidant and a wax:

TABLE 1
Example 1 mixes:

| | MA01 | MA02 | MA03 | MA06 | MA07 | MA08 | MA09 | MA10 | MA11 |
|---|---|---|---|---|---|---|---|---|---|
| | (W) | (W) | (F) | (F) | (F) | (F) | (F) | (F) | (F) |
| SBR | 100.0 | 100.0 | 100.0 | 100.0 | 100.0 | 100.0 | 100.0 | 100.0 | 100.0 |
| AeroPerl 100 | 175.0 | 175.0 | 175.0 | 175.0 | 175.0 | 175.0 | 175.0 | 175.0 | 175.0 |
| Si266 | 9.9 | | | | | | | | |
| Si75 | | 10.2 | | | | | | | |
| SI363 | | | 20.6 | | | | | | |
| MESPT | | | | 13.5 | | | | | |
| NXT regular | | | | | 11.6 | | | | |
| NXT v45 | | | | | | 11.6 | | | |
| DPS18 | | | | | | | 17.5 | | |
| Octeo | | | | | | | | 11.6 | |
| Si69 | | | | | | | | | 11.3 |
| AgriPure 80 | 12.0 | 12.0 | 12.0 | 12.0 | 12.0 | 12.0 | 12.0 | 12.0 | 12.0 |
| (HTO) | | | | | | | | | |
| Escorez 5600 | 60.0 | 60.0 | 60.0 | 60.0 | 60.0 | 60.0 | 60.0 | 60.0 | 60.0 |
| SAD | 3.0 | 3.0 | 3.0 | 3.0 | 3.0 | 3.0 | 3.0 | 3.0 | 3.0 |
| ZNO | 1.0 | 1.0 | 1.0 | 1.0 | 1.0 | 1.0 | 1.0 | 1.0 | 1.0 |
| S | 2.1 | 1.8 | 2.1 | 2.1 | 2.1 | 2.1 | 2.1 | 2.1 | 0.8 |
| CBS | 2.3 | 2.3 | 2.3 | 2.3 | 2.3 | 2.3 | 2.3 | 2.3 | 2.3 |

Results: The aspects of the uncured rubber were evaluated after milling. Those mixes with the best aspect, having a smooth grey surface were mixes MA01, MA02, MA10 and MA09 representing the mixes with Si-266, Si-75, Octeo, and DPS18.

The NXT silane and Si-363 mixes, MA07, MA08 and MA03 appeared to have poor aspect appearing rough tan surface and with a grainy appearance. Surprisingly NXT silanes had poor aspect and surface roughness of the green rubber mixes. Generally these NXT silanes show good stability and less reactivity than Si-69 when mixed with silica, but did not show those advantages with the Aeroperl aluminum oxide.

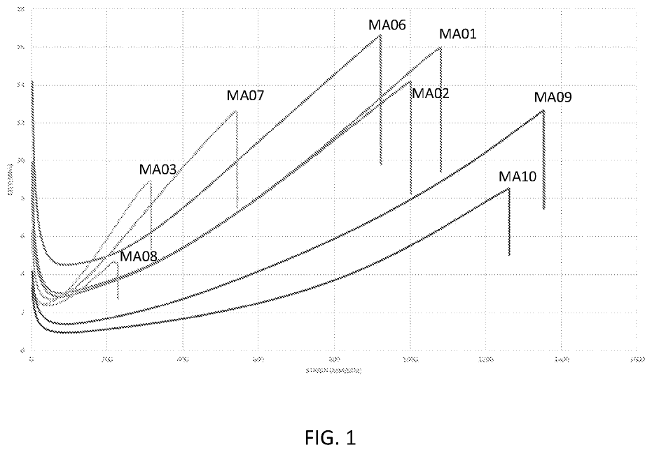

Tensile Properties: These tests make it possible to determine the elasticity stresses and the properties at break. Unless indicated otherwise, they are carried out in accordance with standard ASTM D 412, 1998 (test specimen C). All these tensile measurements are carried out under normal temperature and relative humidity conditions, according to standard ASTM D 1349, 1999, and reported in Table 2 and shown in FIG. 1.

TABLE 2
Example 1 results:

| | MA01 | MA02 | MA03 | MA06 | MA07 | MA08 | MA09 | MA10 | MA11 |
|---|---|---|---|---|---|---|---|---|---|
| | (W) | (W) | (F) | (F) | (F) | (W) | (F) | (F) | (W) |
| Strain At | 1075 | 1000 | 300 | 922 | 544 | 230 | 1350 | 1262 | 881 |
| break (mm/mm) | | | | | | | | | |
| Stress At | 16.0 | 14.0 | 9.0 | 16.5 | 12.6 | 4.7 | 12.5 | 8.5 | 7.9 |
| break (MPa) | | | | | | | | | |

This example utilized Aeropearl alumina with different silanes. The test results showed that silanes having a sulfur bridge having less than an average of 2.4 sulfurs produced a rubber composition with good tensile properties. For example, example Si-363 contains a thiol head group. This is considered the most reactive sulfur containing silane and resulted in poor tensile properties. The NXT mixes, MA07 and MA08 had poor tensile results which correlated to evidence of higher reactivity observed from the poorer aspect after mixing. The mix MA11 comprising Si-69 having an average of 3.8 sulfurs also showed poor tensile tests. The mixes having a silanes having a sulfur bridge and having less than an average of 2.4 sulfurs in the sulfur bridge, such as the mixes using Si266 silane, MA01; Si75 silane, MA02; MESPT silane, MA06; DPS silane, MA09 and Octeo silane, MA10, showed good results.

### Example 2

In this example Baikalox alumina-reinforced compositions are using different silanes. In this example, the components listed in Table 3 below expressed as weights per hundred parts of elastomer, combined with an antidegradant package comprising an antioxidant and a wax:

TABLE 3
Example 2 mixes:

| | MB01 | MB02 | MB03 | MB04 | MB05 | MB06 | MB07 |
|---|---|---|---|---|---|---|---|
| SBR | 100.0 | 100.0 | 100.0 | 100.0 | 100.0 | 100.0 | 100.0 |
| Sil160 MP | 110.0 | | | | | | |
| Baikalox | | 177.0 | 177.0 | 177.0 | 177.0 | 177.0 | |
| ALU65 | | | | | | | 177.0 |
| SI75 | | 10.8 | | | | | |
| NXT regular | | | 12.2 | | | | |
| (new) | | | | | | | |
| SI266 | | | | 10.5 | | | 6.8 |
| OCTEO | | | | | 6.25 | | |
| SI69 | 11.0 | | | | | 12.0 | |
| MPS | | | | | 5.1 | | |
| DPG | 2.4 | | | | | | |
| AgriPure | 12.0 | 12.0 | 12.0 | 12.0 | 12.0 | 12.0 | 12.0 |
| 80 (HTO) | | | | | | | |
| Escorez | 60.0 | 60.0 | 60.0 | 60.0 | 60.0 | 60.0 | 60.0 |
| 5600 | | | | | | | |
| SAD | 3.0 | 3.0 | 3.0 | 3.0 | 3.0 | 3.0 | 3.0 |
| ZNO | 0.9 | 0.9 | 0.9 | 0.9 | 0.9 | 0.9 | 0.9 |
| Sulfur | 0.8 | 1.8 | 2.1 | 2.1 | 2.1 | 2.1 | 2.1 |
| CBS | 2.3 | 2.3 | 2.3 | 2.3 | 2.3 | 2.3 | 2.3 |

TABLE 4
Example 2 results:

| | MB01 | MB02 | MB03 | MB04 | MB05 | MB06 | MB07 |
|---|---|---|---|---|---|---|---|
| Strain At | 725 | 1100 | 500 | 1050 | 650 | 650 | 1220 |
| break (mm/mm) | | | | | | | |
| Stress At | 18.6 | 17.0 | 12.3 | 16.0 | 12.3 | 10.5 | 15.5 |
| break (MPa) | | | | | | | |

The results here show that the alumina filled mix using Si-69 MB06 was not similar to the silica filled mix using Si-69 MB01. The results of Example 2 also show the same trend as shown in Example 1, namely, that alumina filled mixes using a silane having a sulfur bridge and an average of 2.4 sulfurs or less show favorable tensile properties while more reactive silanes, or silanes having more sulfurs show less favorable tensile properties. ALU65, another alumina from Evonik was tested using Si-266 (MB07) showing good tensile properties similar to the Baikalox and Si-266 (MB04).

### Example 3

In this example silica-reinforced compositions are using different silanes and serve as reference to the alumina reinforced mixes in Example 2 above. In this example, the components listed in Table 5 below expressed as weights per hundred parts of elastomer, combined with an antidegradant package comprising an antioxidant and a wax:

TABLE 5
Example 3 mixes.

| Component | MC01 | MC02 | MC03 | MC04 | MC05 | MC06 | MC07 | MC08 |
|---|---|---|---|---|---|---|---|---|
| SBR | 100.0 | 100.0 | 100.0 | 100.0 | 100.0 | 100.0 | 100.0 | 100.0 |
| SI75 | | 10.8 | | | | | | |
| SI363 | | | 11.0 | | | | | 20.0 |
| SI266 | | | | 9.7 | | | | |
| (new cont) | | | | | | | | |
| SIL160 MP | 110.0 | 110.0 | 110.0 | 110.0 | 110.0 | 110.0 | 110.0 | 110.0 |
| NXT regular | | | | | 14.8 | | 7.4 | |
| (new) | | | | | | | | |
| MPS | | | | | | 4.9 | | |
| OCTEO | | | | | | 5.9 | | |
| DPS18 | | | | | | | 7.5 | |
| AgriPure | 12.0 | 12.0 | 12.0 | 12.0 | 12.0 | 12.0 | 12.0 | 12.0 |
| 80 (HTO) | | | | | | | | |
| Escorez | 60.0 | 60.0 | 60.0 | 60.0 | 60.0 | 60.0 | 60.0 | 60.0 |
| 5600 | | | | | | | | |
| DPG | 2.4 | 2.4 | 2.4 | 2.4 | 2.4 | 2.4 | 2.4 | 2.4 |
| Si69 | 11.0 | | | | | | | |
| SAD | 3.0 | 3.0 | 3.0 | 3.0 | 3.0 | 3.0 | 3.0 | 3.0 |
| ZNO | 0.9 | 0.9 | 0.9 | 0.9 | 0.9 | 0.90 | 0.9 | 0.9 |
| Sulfur | 0.9 | 0.9 | 0.9 | 0.9 | 0.9 | 0.9 | 0.9 | 0.9 |
| CBS | 2.3 | 2.3 | 2.3 | 2.3 | 2.3 | 2.3 | 2.3 | 2.3 |

TABLE 6
Example 3 results.

| Component | MC01 | MC02 | MC03 | MC04 | MC05 | MC06 | MC07 | MC08 |
|---|---|---|---|---|---|---|---|---|
| Strain At | 823 | 971 | 752 | 870 | 954 | 788 | 1192 | 415 |
| break (mm/mm) | | | | | | | | |
| Stress At | 20.1 | 19.0 | 16.8 | 19.1 | 18.6 | 17.4 | 14.8 | 14.1 |
| break (MPa) | | | | | | | | |

The results of example 3 show that silica filled mixes do not have as much variation in tensile properties as was observed with the alumina mixes in examples 1 and 2 above and reinforces the surprising results obtained by using an alumina filler with a silane having a sulfur bridge and less than 2.4 sulfurs.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

The terms “a,” “an,” and the singular forms of words shall be taken to include the plural form of the same words, such that the terms mean that one or more of something is provided. The terms “at least one” and “one or more” are used interchangeably. Ranges that are described as being “between a and b” are inclusive of the values for “a” and “b.”

The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

What is claimed is:

1. A rubber composition comprising:
a dienic rubber elastomer;
a reinforcing alumina filler;
a silane coupling agent having 2.5 or less on average bridging sulfurs which is not a blocked mercapto silane; and
a vulcanizing system.

2. The rubber composition of claim 1 wherein the silane coupling agent has 2.4 or less on average bridging sulfurs.

3. The rubber composition of claim 1 wherein the dienic rubber elastomer is styrene-butadiene rubber.

4. The rubber composition of claim 1 wherein the reinforcing alumina has a NSA by volume of 200 to 8500 m²/cm³.

5. The rubber composition of claim 1 where the silane coupling agent is Si75 or Si266.

6. The rubber composition of claim 1 further comprising an accelerator.

7. The rubber composition of claim 1 further comprising an anti-oxidation agent.

8. The rubber composition of claim 1 further comprising an anti ozonate.

9. The rubber composition of claim 1 wherein the reinforcing alumina filler is present in the amount in the range of 80 phr to 185 phr.

10. The rubber composition of claim 3 wherein the reinforcing alumina has a NSA by volume of 200 to 8500 m²/cm³.

11. The rubber composition of claim 10 where the silane coupling agent is Si75 or Si266.

12. The rubber composition of claim 11 further comprising an accelerator.

13. The rubber composition of claim 12 further comprising an anti-oxidation agent.

14. The rubber composition of claim 13 wherein the reinforcing alumina filler is present in the amount in the range of 80 phr to 185 phr.

15. A tire comprising the rubber composition of claim 1.

16. A rubber composition comprising:
a styrene-butadiene rubber;
a reinforcing alumina filler having a NSA by volume of 200 to 8500 m²/cm³;
a silane coupling agent having 2.5 or less on average bridging sulfurs which is not a blocked mercapto silane and having 2.4 or less on average bridging sulfurs; and
a vulcanizing system.

17. The rubber composition of claim 16 where the silane coupling agent is Si75 or Si266.

18. The rubber composition of claim 16 further comprising an accelerator.

19. The rubber composition of claim 16 further comprising an anti-oxidation agent.

20. The rubber composition of claim 16 wherein the reinforcing alumina filler is present in the amount in the range of 80 phr to 185 phr.
